(19) United States
(12) Patent Application Publication
(10) Pub. No.: US 2016/0096970 A1
(43) Pub. Date: Apr. 7, 2016

(54) COATING COMPOSITION, A METHOD OF MAKING A COATING COMPOSITION, A COATED ARTICLE, AND A METHOD OF MAKING A COATED ARTICLE

(71) Applicant: STO CORP., Atlanta, GA (US)

(72) Inventors: Daniel Hartley, Peachtree City, GA (US); Harry Carter Menzel, Brandon, MS (US); Christopher Smith, Sandy Springs, GA (US)

(21) Appl. No.: 14/871,406

(22) Filed: Sep. 30, 2015

Related U.S. Application Data
(60) Provisional application No. 62/059,109, filed on Oct. 2, 2014.

(51) Int. Cl. C09D 133/08

(52) U.S. Cl. CPC C09D 133/08; C08K 5/17

(57) ABSTRACT

The present disclosure relates to a coating composition, a method of making a coating composition, a coated article, and a method of making a coated article. The coating composition can include a first dispersion comprising an aqueous acrylic resin component and a second dispersion combined with the first dispersion, wherein the second dispersion comprises an organosilane component and a pigment indicator component.

### RELATED APPLICATION

This application claims the benefit of priority to U.S. Provisional Application No. 62/059,109, filed Oct. 2, 2014. The provisional application identified above is hereby incorporated by reference in its entirety herein to provide continuity of disclosure.

### TECHNICAL FIELD

The present disclosure relates to a coating composition, a method of making a coating composition, a coated article, and a method of making a coated article.

### BACKGROUND

Coatings containing silicone elastomers are commonly used in the construction of exterior wall systems. Silicone elastomer coatings are often used as decorative finish coatings and air and/or moisture barriers in such wall systems. However, the presence of silicone in these layers often leads to poor adhesion of exterior coatings applied directly to the silicone elastomer layers. For example, acrylic-based coatings tend to exhibit adhesion issues over time when applied to silicone elastomer substrates. Consequently, there is a need to provide a coating system that can address the adhesion issues typically faced when coating a silicone elastomer layer substrate. These and other aspects are addressed by the present disclosure.

### SUMMARY

The present disclosure encompasses a coating composition, a method of making a coating composition, a coated article, and a method of making a coated article. The present disclosure encompasses a coating composition comprising an aqueous acrylic resin component, an organosilane component, and a pigment indicator component.

In one embodiment, the present disclosure encompasses a coating composition comprising: a first dispersion comprising an aqueous acrylic resin component; and a second dispersion combined with the first dispersion, wherein the second dispersion comprises an organosilane component and a pigment indicator component. In one aspect, the organosilane component can comprise an epoxy-silane. In another aspect, the epoxy-silane can comprise γ-Glycidyloxypropyltrimethoxysilane. In a further aspect, the first dispersion can comprise at least about 20% by weight of the aqueous acrylic resin component. In still another aspect, the coating composition can comprise less than about 25% by weight of the second dispersion. In yet a further aspect, the first dispersion can comprise a dispersant. In another aspect, the dispersant can comprise 2-amino-2-methyl-1-propanol. In still another aspect, the first dispersion can comprise a surfactant. In yet another aspect, the surfactant can comprise a polyether-modified siloxane. In a further aspect, the first dispersion can comprise a rheology modifier. In a further aspect, the rheology modifier can comprise 1-methyl-2-pyrrolidone.

A method of making the coating composition encompassed by the present disclosure comprises the steps of providing the first dispersion comprising the aqueous acrylic resin component, providing the second dispersion comprising the organosilane component and the pigment indicator component, blending the second dispersion into the first dispersion, thereby producing the coating composition. In another aspect, the organosilane component of the provided second dispersion can comprise an epoxy-silane. In a further aspect, the epoxy-silane comprises γ-Glycidyloxypropyltrimethoxysilane. In yet another aspect, the provided first dispersion can comprise at least about 20% by weight of the aqueous acrylic resin component. In still a further aspect, the coating composition formed thereby comprises less than about 25% by weight of the second dispersion. In another aspect, the provided first dispersion comprises less than about 60% by weight of the aqueous acrylic resin component. In yet another aspect, the coating composition exhibits a volatile organic compound concentration of less than about 25% by weight. In still a further aspect, wherein the coating composition exhibits a volatile organic compound concentration of less than about 10% by weight.

A coated article encompassed by the present disclosure comprises a substrate; a first coating applied to the substrate, wherein the first coating comprises a silicone elastomer component; and a second coating applied to the first coating after the first coating is cured, wherein the second coating comprises the first dispersion comprising the aqueous acrylic resin component and the second dispersion comprising the organosilane component and the pigment indicator component. In one aspect, the organosilane of the second dispersion of the second coating of the coated article comprises an epoxy-silane. In a further aspect, the epoxy-silane can comprise γ-Glycidyloxypropyltrimethoxysilane.

The present disclosure also encompasses a coating system comprising a kit comprising a first container containing the first dispersion comprising the aqueous acrylic resin component, and a second container containing the second dispersion comprising the organosilane component and the pigment indicator component. In one aspect, the organosilane component in the second container can comprise γ-Glycidyloxypropyltrimethoxysilane.

A method of making a coated article encompassed by the present disclosure comprises the steps of providing a substrate; applying a first coating to the substrate, wherein the first coating comprises a silicone elastomer component; preparing a coating composition, wherein preparing the coating composition comprises providing a first dispersion comprising an aqueous acrylic resin component, providing a second dispersion comprising an organosilane component and a pigment indicator component; blending the second dispersion with the first dispersion to form the coating composition; and applying a second coating to the first coating after the first coating is cured, wherein the second coating comprises the coating composition, thereby producing the coated article.

In another embodiment, the present disclosure encompasses a coating composition comprising: a first dispersion comprising an aqueous acrylic resin component, a filler, a dispersant, a surfactant, a rheology modifier, and a coalescing agent; and, a second dispersion combined with the first dispersion, wherein the second dispersion comprises an organosilane component and a pigment indicator component. In one aspect, the organosilane component can comprise an epoxy-silane. In another aspect, the epoxy-silane comprises γ-Glycidyloxypropyltrimethoxysilane. In a further aspect, the coating composition can exhibit a volatile organic compound concentration of less than about 10% by weight. In a further aspect, the present disclosure encompasses a coated article comprising a substrate; a first coating applied to the substrate, wherein the first coating comprises a silicone elastomer component; and, a second coating applied to the first coating after the first coating is cured, wherein the second coating comprises the coating composition comprising the first dispersion and the second.

In an alternative embodiment, the present disclosure encompasses a coating composition comprising: a first dispersion comprising about 20% to about 60% by weight of an aqueous acrylic resin component; and a second dispersion comprising about 25% to about 95% by weight of an organosilane component, wherein the coating composition comprises about 0.1% to about 20% by weight of the second dispersion. A process for producing the coating composition encompassed by the present disclosure comprises the steps of providing a first dispersion comprising about 20% to about 60% by weight of an aqueous acrylic resin component, providing a second dispersion comprising about 25% to about 95% by weight of an organosilane component, blending the second dispersion into the first dispersion, thereby producing the coating composition comprising about 0.1% to about 20% by weight of the second dispersion. A coated article encompassed by the present disclosure comprises a substrate comprising a first coating, wherein the first coating comprises a silicone elastomer component; and a second coating applied to the first coating after the first coating is cured, wherein the second coating comprises a coating composition comprising a first dispersion comprising about 20% to about 60% by weight of an aqueous acrylic resin component and a second dispersion comprising about 25% to about 95% by weight of an organosilane component, wherein the coating composition comprises about 0.1% to about 20% by weight of the second dispersion. A method of making a coated article encompassed by the present disclosure comprises the steps of providing a substrate comprising a first coating comprising a silicone elastomer component, providing a second coating comprising a coating composition comprising a first dispersion comprising about 20% to about 60% by weight of an aqueous acrylic resin component and a second dispersion comprising about 25% to about 95% by weight of an organosilane component, wherein the coating composition comprises about 0.1% to about 20% by weight of the second dispersion, applying the second coating onto the substrate coated with the first coating after the first coating is cured, thereby producing the coated article.

In an yet another alternative embodiment, the present disclosure encompasses a coating composition comprising: a first dispersion comprising about 20% to about 60% by weight of an aqueous acrylic resin component; and a second dispersion comprising about 25% to about 95% by weight of an organosilane component, and about 0.01% to about 25% by weight of a pigment indicator component, wherein the coating composition comprises about 0.1% to about 20% by weight of the second dispersion. A process for producing the coating composition encompassed by the present disclosure comprises the steps of providing a first dispersion comprising about 20% to about 60% by weight of an aqueous acrylic resin component, providing a second dispersion comprising about 25% to about 95% by weight of an organosilane component, and about 0.01% to about 25% by weight of a pigment indicator component, blending the second dispersion into the first dispersion, thereby producing the coating composition comprising about 0.15% to about 20% by weight of the second dispersion. A coated article encompassed by the present disclosure comprises a substrate comprising a first coating, wherein the first coating comprises a silicone elastomer component; and a second coating applied to the first coating after the first coating is cured, wherein the second coating comprises a coating composition comprising a first dispersion comprising about 20% to about 60% by weight of an aqueous acrylic resin component and a second dispersion comprising about 25% to about 95% by weight of an organosilane component, and about 0.01% to about 25% by weight of a pigment indicator component, wherein the coating composition comprises about 0.1% to about 20% by weight of the second dispersion. A method of making a coated article encompassed by the present disclosure comprises the steps of providing a substrate comprising a first coating comprising a silicone elastomer component, providing a second coating comprising a coating composition comprising a first dispersion comprising about 20% to about 60% by weight of an aqueous acrylic resin component and a second dispersion comprising about 25% to about 95% by weight of an organosilane component and about 0.01% to about 25% by weight of a pigment indicator component, wherein the coating composition comprises about 0.1% to about 20% by weight of the second dispersion, applying the second coating to the substrate coated with the first coating after the first coating is cured, thereby producing the coated article.

In still a further alternative embodiment, the present disclosure encompasses a coating composition, a method of producing a coating composition, a coated article made from a coating composition, and a method of making a coated article in accordance with any of the preceding embodiments, wherein the organosilane component comprises a bifunctional organosilane.

In another alternative embodiment, the present disclosure encompasses a coating composition, a method of producing a coating composition, a coated article made from a coating composition, and a method of making a coated article in accordance with any of the preceding embodiments, wherein the organosilane component comprises an epoxy-silane.

In yet another alternative embodiment, the present disclosure encompasses a coating composition, a method of producing a coating composition, a coated article made from a coating composition, and a method of making a coated article in accordance with any of the preceding embodiments, wherein the organosilane component comprises γ-Glycidyloxypropyltrimethoxysilane.

In yet another alternative embodiment, the present disclosure encompasses a coating composition, a method of producing a coating composition, a coated article made from a coating composition, and a method of making a coated article in accordance with any of the preceding embodiments, wherein second dispersion comprises about 95% by weight of γ-Glycidyloxypropyltrimethoxysilane.

In another alternative embodiment, the present disclosure encompasses a coating composition, a method of producing a coating composition, a coated article made from a coating composition, and a method of making a coated article in accordance with any of the preceding embodiments, wherein the coating composition further comprises at least one dispersant component.

In another alternative embodiment, the present disclosure encompasses a coating composition, a method of producing a coating composition, a coated article made from a coating composition, and a method of making a coated article in accordance with any of the preceding embodiments, wherein the coating composition further comprises at least one surfactant component.

In yet another alternative embodiment, the present disclosure encompasses a coating composition, a method of producing a coating composition, a coated article made from a coating composition, and a method of making a coated article in accordance with any of the preceding embodiments, wherein the coating composition further comprises at least one rheology modifier component.

In still another alternative embodiment, the present disclosure encompasses a coating composition, a method of producing a coating composition, a coated article made from a coating composition, and a method of making a coated article in accordance with any of the preceding embodiments, wherein the coating composition further comprises at least one rust inhibitor component.

In yet another alternative embodiment, the present disclosure a coated article made from a coating composition, and a method of making a coated article in accordance with any of the preceding embodiments, wherein the coated article exhibits an average resistance-to-peel strength of at least about 0.26 kN/m.

These and other aspects of the present disclosure are set forth in greater detail below.

### DETAILED DESCRIPTION

As used herein, the singular forms of “a,” “an,” and “the” encompasses the plural form thereof unless otherwise indicated. As used herein, the phrase “at least one” includes all numbers of one and greater. The ranges used herein include all values that would fall within the stated range, including values falling intermediate of whole values. As used herein, the term “and/or” refers to one or all of the listed elements or a combination of any two or more of the listed elements. As used herein, the values described as “% by weight” are calculated on the weight of the composition in which the component is found. As used herein, the term “cured” refers to the cross-linking and setting of a coating applied to a substrate, wherein the coating is exposed to ambient outdoor conditions for at least sixty days after application thereof to the substrate.

The present disclosure encompasses coating compositions, methods of making coating compositions, coated articles, and methods of making coated articles. The present disclosure encompasses coating compositions that comprise at least one aqueous acrylic resin component, at least one organosilane component and at least one pigment indicator component. In another aspect, the coating compositions of the present disclosure can be formed by combining a first dispersion comprising an aqueous acrylic resin component with a second dispersion comprising an organosilane component and a pigment indicator component. The coating compositions encompassed by the present disclosure can be used to coat a layer comprising a silicone elastomer component formed on a substrate of wall or other portion of a building or other structure. In one aspect, the coating composition of the present disclosure also can be used to produce a coated article comprising a first layer comprising a silicone elastomer component and a second layer applied to the first layer, wherein the second layer comprises an aqueous acrylic resin component, an organosilane component, and a pigment indicator component.

The present disclosure also comprises a coating system comprising a first dispersion and a second dispersion. The coating system can be provided as a kit with the first dispersion provided in a first container and the second dispersion provided in a second container. The first dispersion comprises an aqueous acrylic resin component, and the second dispersion comprises an organosilane component and a pigment indicator component. A pigment indicator component can be provided in the second dispersion to help ensure that the second dispersion is combined with the first dispersion prior to application of the coating composition to a surface to be coated. The second dispersion can be added to the first dispersion to produce a coating composition. In one aspect, the second dispersion can be added to the first dispersion at a ratio of about 50 ml of the second dispersion to about 3.79 1 of the first dispersion and mixed to produce a coating composition. In another aspect, the second dispersion can be added to the first dispersion in a range of about 0.01% to about 20% by weight of the second dispersion on the weight of the first dispersion. In yet another aspect, the second dispersion can be added to the first dispersion at about 4.6% by weight of the second dispersion on the weight of the first dispersion. In a further aspect, the upper limit of the range of the amount of the second dispersion that can be added to the first dispersion 5%, 10%, 15% or 20% by weight on the weight of the first dispersion. In another aspect, the lower limit of the range of the amount of the second dispersion that can be added to the first dispersion 0.01%, 0.02%, 0.03%, 0.04%, 0.05%, 1%, 2%, 3% or 4% by weight of the second dispersion on the weight of the first dispersion. These and other features of the present disclosure are described as follows.

The coating compositions encompassed by the present disclosure comprise at least one aqueous acrylic resin component. The aqueous acrylic resin components encompassed by the present disclosure can comprise one or more acrylate monomers or polymers. The acrylate monomers from which the acrylic resins can be selected from comprise one or more methacrylate, methyl acrylate, ethyl acrylate, hydroxyethyl methacrylate, butyl acrylate, butyl methacrylate, hexyl acrylate, 2-ethylhexyl acrylate, octyl acrylate and isooctyl acrylate, n-decyl acrylate, isodecyl acrylate. tert-butyl acrylate, hexyl methacrylate, isobutyl methacrylate, isopropyl methacrylate, 2-hydroxyethyl acrylate,acrylamide, and other acrylic groups. The acrylic resins can be provided as dispersions containing various solvents, which can include water. In one aspect, the acrylic resin can comprise about 44% to about 47% by weight of acrylic polymer and about 53% to about 56% by weight water. Examples of acrylic resins that can be used in the coating compositions encompassed by the present disclosure are commercially available as AVANSE™ MV 100, AVANSE™ MV 200, and AVANSE™ from The Dow Chemical Company. Other suitable acrylic resins are contemplated by the present disclosure.

The coating compositions of the present disclosure can comprise a first dispersion and a second dispersion, wherein the second dispersion is added to the first dispersion with mixing to produce the coating composition. The first dispersion can comprise about 20% to about 60% by weight of an aqueous acrylic resin component. In one aspect, the upper limit of the range of the aqueous acrylic resin component in the first dispersion can be about 35%, 36%, 37%, 38%, 39%, 40%, 45%, 50%, 55%, or 60% by weight. In another aspect, the lower limit of the range of acrylic resin component in the first dispersion can be about 20%, 25%, 30%, 31%, 32%, 33% or 34% by weight. In one aspect, the first dispersion can comprise about 35% by weight of an acrylic resin component.

The second dispersion can comprise about 25% to about 95% by weight of an organosilane component. In one aspect, the upper limit of the range of the organosilane component present in the second dispersion can be about 60%, 65%, 70%, 75%, 80%, 85%, 90% ₒᵣ 95% by weight. In another aspect, the lower limit of the range of the organosilane component present in the second dispersion can be about 25%, 30%, 35%, 40%, 45%, 50%, 55%, 60%, 65%, 70%, 75%, 80%, 85%, 90%, 91%, 92%, 93%, or 94% by weight. In one aspect, the second dispersion can comprise about 95% by weight of an organosilane component.

The organosilane components of the present disclosure can include one or more components that exhibit the general molecular structure of:

X—R—Si(OR′)₃

where X can be a non-hydrolysable organic moiety comprising an epoxy, amino, vinyl methacryloxy, or sulfido moiety; R can be an aryl or alkyl chain, in one embodiment comprising a propyl moiety; OR′ can be a moiety that can be hydrolysable, such as an alkoxy group (e.g. methoxy, ethoxy, isoproxy) or an acetoxy group. The organosilanes that can be used in the coating compositions of the present disclosure can be bifunctional, wherein each molecule exhibits at least two reactive binding sites. One example of an organosilane that is encompassed herein is γ-Glycidyloxypropyltrimethoxysilane, which is commercially available as DYNASYLAN® GLYMO from Evonik Industries AG, Essen, Germany.

In another embodiment, the second dispersion can comprise about 0.01% to about 25% by weight of a pigment indicator component. Alternatively, the second dispersion can comprise about 0.01% to about 25% by weight of a first pigment indicator component and about 0.01% to about 25% by weight of a second pigment indicator component. In one aspect, the upper limit of the range of a pigment indicator component present in the second dispersion can be about 5%, 10%, 15%, 20% or 25% by weight. In another aspect, the lower limit of the range of the pigment indicator component present in the second dispersion can be about 0.01%, 0.05%, 0.1%, 0.5%, or 1% by weight. In one aspect, the second dispersion can comprise about 1% by weight of first pigment indicator component and about 4% by weight of a second pigment indicator component. Examples of pigment indicator components include a pigment commercially available as EPS 732 Phthalo Blue, and a pigment commercially available as EPS 796 Carbon Black both from EPS Materials.

The coating compositions encompassed by the present disclosure also can include one or more dispersants. Example dispersants that can be used singly or in combination with each other in a coating composition encompassed by the present disclosure include an aqueous dispersion comprising 2-amino-2-methyl-1-propanol, an example of which is AMP-95® of ANGUS® Chemical Company of Buffalo Grove, Ill., a dispersion comprising an ammonium salt of a hydrophobic copolymer dispersant and propanediol commercially available as DOW TAMOL® 681 Dispersant from Rohm and Haas Europe Trading EPS UK Branch A Subsidiary of The Dow Chemical Company, Coventry, England, UK. One or more dispersants can be provided in the first dispersion, which also comprises an aqueous acrylic resin component.

The coating compositions encompassed by the present disclosure also can include one or more surfactants. Example surfactants that can be used singly or in combination with each other in a coating composition encompassed by the present disclosure include a dispersion comprising a polyether-modified siloxane commercially available as BYK-349 from BYK USA Inc., Wallingford, Conn. and a nonionic surfactant dispersion comprising an octyphenol ethoxylate component commercially available as TRITON™ X-405 from the Dow Chemical Company. One or more surfactants can be provided in the first dispersion, which also comprises an aqueous acrylic resin component. The first dispersion can comprise about 0.1% to about 4% by weight of surfactant component. In one aspect, the upper limit of the range of the surfactant component in the first dispersion can be about 2%, 3% or 4% by weight. In another aspect, the lower limit of the range of filler component in the first dispersion can be about 0.1%, 0.2%, 0.4%, 0.5% or 1% by weight. In one aspect, the first dispersion can comprise about 1% by weight of a first surfactant and about 0.5% by weight of a second surfactant.

The coating compositions encompassed by the present disclosure also can include one or more rheology modifiers. Examples of rheology modifiers that can be used singly or in combination in a coating composition encompassed by the present disclosure include a dispersion comprising 1-methyl-2-pyrrolidone and lithium chloride commercially available as BYK 420 from BYK USA Inc., another modifier commercially available as OPTIFLO L100 from BYK-Chemie GmbH, and yet another modifier commercially available as OPTIFLO TVS-VF from BYK-Chemie GmbH. One or more rheology modifiers can be provided in the first dispersion comprising an aqueous acrylic resin component. The first dispersion can comprise about 0.2% to about 3% by weight of a rheology modifier component. In one aspect, the upper limit of the range of the rheology modifier component in the first dispersion can be about 0.5%, 1%, 2% or 3% by weight. In another aspect, the lower limit of the range of rheology modifier component in the first dispersion can be about 0.2%, 0.4%, 0.6%, 0.8%, or 1% by weight. In one aspect, the first dispersion can comprise about 0.2% by weight of a first rheology modifier component, about 1.6% by weight of a second rheology modifier component, and about 0.8% by weight of a third rheology modifier component.

The coating compositions encompassed by the present disclosure also can include one or more coalescing agents. Examples coalescing agents that can be used in a coating composition of the present disclosure includes EPS® 9147 commercially available from EPS Materials, Marengo, Ill., and an ester alcohol, such as 2,2,4-Trimethyl-1,3-pentanediol mono-isobutyrate, commercially available as Eastman TEXANOL™ Ester Alcohol from Eastman Chemical Company, Kingsport, Tenn. One or more coalescing agents can be provided in the first dispersion comprising an aqueous acrylic resin component.

The coating compositions encompassed by the present disclosure also can include one or more rust inhibitors. An example of a rust inhibitor that can be used in a coating composition encompassed by the present disclosure is sodium nitrite. One or more rust inhibitors can be provided in the first dispersion comprising an aqueous acrylic resin component.

The coating compositions encompassed by the present disclosure also can include one or more fillers. An example of a filler that can be used in a coating composition encompassed by the present disclosure is a calcium carbonate filler commercially available as Imerfill™ 25 from IMERYS, Roswell, Ga. One or more fillers can be provided in the first dispersion comprising an aqueous acrylic resin. The first dispersion can comprise about 1% to about 30% by weight of filler component. In one aspect, the upper limit of the range of the filler component in the first dispersion can be about 25% or 30% by weight. In another aspect, the lower limit of the range of filler component in the first dispersion can be about 1%, 5%, 10%, 15% or 20% by weight. In one aspect, the first dispersion can comprise about 22% by weight of filler component.

One example of a coating composition encompassed by the present disclosure comprises a first dispersion and a second dispersion blended with the first dispersion. The first dispersion comprises about 24.5% by weight water, about 0.2% by weight AMP-95®, about 0.2% by weight sodium nitrite, about 1% by weight EPS 9147, about 1% by weight TEXANOL™ Ester Alcohol, about 0.3% by weight BYK 022, about 1% by weight TAMOL™ 681, about 0.5% by weight BYK 349, about 0.2% by weight Acticide GA, about 22% by weight Imerfill 25, about 10% by weight Kronos 2310, about 35% by weight AVANSE™ MV 200, about 1% by weight Triton X-405, about 0.5% by weight BYK 093, about 0.2% by weight BYK 420, about 1.6% by weight OPTIFLO L100, and about 0.8% by weight OPTIFLO TVS-VF. The second dispersion comprises about 95% by weight DYNASYLAN® Glymo, about 4% by weight EPS 732 Phthalo Blue, and about 1% by weight EPS 796 Carbon Black. The second dispersion is mixed into the first dispersion in a ratio of about 50 ml of the second dispersion per about 3.791 of the first dispersion, or about 4.6% by weight of the second dispersion on the weight of the first dispersion.

The coating compositions encompassed by the present disclosure can be produced using the steps typically used to produce paints and other coatings. As an example, during the first step pigments, dispersants, resins and solvent can be combined in a suitable mixer and then milled to produce a dispersion that is then mixed with other resins, solvents, and additives in a letdown phase.

The coating compositions encompassed by of the present disclosure can exhibit volatile organic compound concentrations of less than about 25% by weight. In another aspect, the coating compositions encompassed by the present disclosure can exhibit volatile organic compound concentrations of less than about 10% by weight. The volatile organic compound concentration of the coating composition can be determined either by arithmetic addition of the known volatile organic compound concentrations of each constituent making up the coating composition or by testing according to the method ASTM D 2369-03. Examples of the coating compositions encompassed by the present disclosure were found to have volatile organic compound concentrations of less than about 10% by weight when the volatile organic compound concentrations of the constituent components of the coating concentrations were added together to find the total volatile organic compound concentration.

The coating compositions of the present disclosure can be used to produce various coated articles, including multi-component wall systems. The coating compositions of the present disclosure can be used in the production of exterior wall systems, for such wall systems can include coating layers that comprise a silicone elastomer component. Such silicone elastomer components can be used as air and water barriers and/or decorative finishing layers in an exterior wall system. The coating compositions set forth herein can be applied directly to a silicone elastomer coating layer. The resulting multi-layer barrier can exhibit adhesive properties that are in some cases superior to other coating layers that comprise an aqueous acrylic layer applied directly to a silicone elastomer layer.

The present disclosure encompasses articles coated with the coating composition set forth herein applied directly to a cured coating comprising a silicone elastomer component that when tested via the method set forth in ASTM D4541-09e1 entitled “Standard Test Method For Pull-Off Strength Of Coatings Using Portable Adhesion Testers” exhibits a test result of at least about 50 pounds per square inch (“p.s.i.”) (345 kPa). Alternatively, the present disclosure encompasses an article coated with the coating composition set forth herein applied directly to a cured coating comprising a silicone functional component that when tested via the method set forth in ASTM D4541-09e1 that exhibits failure of the bond between the silicone elastomer component coating and the substrate underlying the coating.

The present disclosure encompasses coated articles coated with the coating compositions set forth herein applied to a cured coating comprising a silicone elastomer component that when tested via the method set forth in ASTM D6862-11, entitled “Standard Test Method for 90 Degree Peel Resistance of Adhesives” exhibits an average resistance-to-peel strength of at least about 1.5 lbf/inch (about 0.26 kN/m). In another aspect, the coated article can exhibit an average resistance-to-peel strength of at least about 2 lbf/inch (about 0.35 kN/m). In yet another aspect, the coated article can exhibit an average resistance-to-peel strength of at least about 3 lbf/inch (about 0.525 kN/m). Examples of coated articles comprising the coating compositions encompassed by the present disclosure exhibited an average resistance-to-peel strength in the range of about 3 lbf/inch (about 0.525 kN/m) to about 8 lbf/inch (about 1.401 kN/m) when tested according to the following procedure.

A coating of Dow Corning® Allguard was applied to rigid substrates, such as fiber cement boards. The coating on the boards was aged outdoors for a period of at least thirty days. The boards were cut to size for use in the test apparatus. Coating compositions encompassed by the present disclosure were applied to the boards at appropriate thicknesses. After seven days, a silyl terminated polyether based sealant was applied to each coating composition to adhere a cotton broadloom cloth strip thereto so as to allow about one to two inches of the cloth to overhang the end of each sample board. The cloth strips exhibited minimum stretch. Once the sealant was cured, a knife was used to cut the sealant and coating composition along the cloth strip so that pulling of the strip would affect only the area of the coating composition disposed under the strip. The overhanging portion of the cloth strip was lifted and the sealant and coating were carefully cut to aid in a smooth start to the test pull. Each sample was mounted in a 90 Degree pull apparatus as described in ASTM D6862-11. The overhanging edges of the cloth strips were clamed to the crosshead of the tensile-elongation machine. Each sample was peel tested at a crosshead speed of 2 inch/minute to a set distance of 3 inches. Calculations were performed according to ASTM D6862-11 and the pounds per linear inch and mode of failure were recorded.

It will be apparent to those skilled in the art that various modifications and variations can be made to the coating compositions, dispersions, systems, coated articles, and methods set forth herein and are contemplated by the present disclosure.

What is claimed is:

1. A coating composition comprising:
a first dispersion comprising an aqueous acrylic resin component; and second dispersion combined with the first dispersion, wherein the second dispersion comprises an organosilane component and a pigment indicator component.

2. The coating composition of claim 1, wherein the organosilane component comprises an epoxy-silane.

3. The coating composition of claim 2, wherein the epoxy-silane comprises γ-Glycidyloxypropyltrimethoxysilane.

4. The coating composition of claim 1, wherein the first dispersion comprises at least about 20% by weight of the aqueous acrylic resin component.

5. The coating composition of claim 1, wherein the coating composition comprises less than about 25% by weight of the second dispersion component.

6. The coating composition of claim 1, wherein the first dispersion further comprises a dispersant component.

7. The coating composition of claim 6, wherein the dispersant component comprises 2-amino-2-methyl-1-propanol.

8. The coating composition of claim 1, wherein the first dispersion further comprises a surfactant.

9. The coating composition of claim 8, wherein the surfactant comprises a polyether-modified siloxane.

10. The coating composition of claim 1, wherein the first dispersion further comprises a rheology modifier.

11. The coating composition of claim 10, wherein the rheology modifier comprises 1-methyl-2-pyrrolidone.

12. A method of making the coating composition of claim 1, the method comprising the steps of:
providing the first dispersion of claim 1;
providing the second dispersion of claim 1; and,
mixing the second dispersion into the first dispersion to form the coating composition of claim 1.

13. The method of claim 12, wherein the organosilane component comprises an epoxy-silane.

14. The method of claim 13, wherein the epoxy-silane comprises γ-Glycidyloxypropyltrimethoxysilane.

15. The method of claim 12, wherein the first dispersion comprises at least about 20% by weight of the aqueous acrylic resin component.

16. The method of claim 12, wherein the coating composition comprises less than about 25% by weight of the second dispersion.

17. The method of claim 15, wherein the first dispersion comprises less than about 60% by weight of the aqueous acrylic resin component.

18. A coated article comprising a substrate; a first coating applied to the substrate, wherein the first coating comprises a silicone elastomer component, and a second coating applied to the first coating after the first coating is cured, wherein the second coating comprises the coating composition of claim 1.

19. The coated article of claim 18, wherein the organosilane component comprises an epoxy-silane.

20. The coated article of claim 18, where the epoxy-silane comprises γ-Glycidyloxypropyltrimethoxysilane.

21. The coated article of claim 19, wherein the coated article exhibits an average resistance-to-peel strength of at least about 0.26 kN/m.

22. The coating composition of claim 1, wherein the coating composition exhibits a volatile organic compound concentration of less than about 25% by weight.

23. The coating composition of claim 1, wherein the coating composition exhibits a volatile organic compound concentration of less than about 10% by weight.

24. A coating system comprising a kit comprising a first container containing the first dispersion of claim 1; and a second container containing the second dispersion of claim 1.

25. The coating system of claim 24, wherein the organosilane component comprises γ-Glycidyloxypropyltrimethoxysilane.

26. A coating composition comprising:
a first dispersion comprising an aqueous acrylic resin component, a filler, a dispersant, a surfactant, a rheology modifier, and a coalescing agent; and,
a second dispersion combined with the first dispersion, wherein the second dispersion comprises an organosilane component and a pigment indicator component.

27. The coating composition of claim 26, wherein the organosilane component comprises an epoxy-silane.

28. The coating composition of claim 27, wherein the epoxy-silane comprises γ-Glycidyloxypropyltrimethoxysilane.

29. The coating composition of claim 26, wherein the coating composition exhibits a volatile organic compound concentration of less than about 25% by weight.

30. The coating composition of claim 26, wherein the coating composition exhibits a volatile organic compound concentration of less than about 10% by weight.

31. A coated article comprising a substrate; a first coating applied to the substrate, wherein the first coating comprises a silicone elastomer component; and, a second coating applied to the first coating after the first coating is cured, wherein the second coating comprises the coating composition of claim 26.

32. The coated article of claim 31, wherein the coated article exhibits an average resistance-to-peel strength of at least about 0.26 kN/m.
